(19) United States
(12) Patent Application Publication
(10) Pub. No.: US 2020/0353925 A1
(43) Pub. Date: Nov. 12, 2020

(54) VEHICLE AND METHOD OF CONTROLLING THE SAME

(71) Applicants: Hyundai Motor Company, Seoul (KR); Kia Motors Corporation, Seoul (KR)

(72) Inventor: Donghyuk KIM, Hwaseong-si (KR)

(73) Assignees: Hyundai Motor Company, Seoul (KR); Kia Motors Corporation, Seoul (KR)

(21) Appl. No.: 16/667,230

(22) Filed: Oct. 29, 2019

(30) Foreign Application Priority Data
May 8, 2019 (KR) 10-2019-0053627

(51) Int. Cl. B60W 30/18; B60W 40/08

(52) U.S. Cl. CPC B60W 30/18; B60W 40/08; B60W 2550/10; B60W 2550/20; B60W 2520/105; B60W 2420/42; B60W 2550/142

(57) ABSTRACT

A vehicle may include a detection sensor configured to detect an object around a vehicle; a driving state of the driver sensing unit configured to detect a driving state of a driver of the vehicle; an acceleration detection unit configured to detect a vehicle body acceleration of the vehicle; and a control unit configured to, upon determining that the driver is unable to control the vehicle on the basis of the detected driving state of the driver, determine a gradient of a road being travelled on by the vehicle on the basis of the detected vehicle body acceleration and determine a travel stop position and a travel stop time point of the vehicle on the basis of the determined gradient of the road.

### CROSS-REFERENCE TO RELATED APPLICATION

The present application claims priority to Korean Patent Application No. 10-2019-0053627, filed on May 8, 2019 in the Korean Intellectual Property Office, the entire contents of which is incorporated herein for all purposes by this reference.

### BACKGROUND OF THE INVENTION

### Field of the Invention

The present invention relates to a vehicle and a method of controlling the same, and more specifically, to a technology of performing an emergency stop on a vehicle in consideration of a traffic situation and a road shape when a driver is unable to drive the vehicle during traveling.

### Description of Related Art

A vehicle refers to an apparatus capable of transporting people or products while travelling on a road or railway. The vehicle may move to various positions mainly using one or more vehicle wheels mounted on a vehicle body. Such a vehicle may include a three-wheeled or four-wheeled vehicle, a two-wheeled vehicle, such as a motorcycle, a construction machine, a bicycle, and a train traveling on a railway arranged on a track.

In modern society, a vehicle is the most common device of transportation, and the number of people using vehicles is increasing. Development of vehicle technology facilitates transportation of long-distance movement and provides conveniences of life. However, in a place having high population density, such as Korea, the increasing use of vehicles may aggravate road traffic situation, frequently causing heavy traffic congestion.

Recently, there have been numerous studies regarding a vehicle provided with an advanced driver assist system (ADAS), which actively provides information related to the state of a vehicle, the state of a driver, and the surrounding environment to reduce the burden on the driver while enhancing the convenience of the driver.

Examples of the ADAS mounted on a vehicle include Smart Cruise Control System, Lane Keeping Assist System, Lane Following Assist, Lane Departure Warning System, Forward Collision Avoidance (FCA), Autonomous Emergency Brake (AEB), and the like. Such a system is designed to perform collision avoidance by determining the risk of colliding with an opposite vehicle or an intersecting vehicle, and bringing the subject vehicle to an emergency stop, and to control the vehicle to travel while keeping a distance to a preceding vehicle, or assist the running vehicle in preventing from departing from the lane.

Furthermore, examples of the ADAS may include a driver state warning system for monitoring negligence of keeping eyes forward or drowsiness of a driver who is driving the vehicle. In recent years, various studies have been conducted on a technique for performing emergency stop on a vehicle in consideration of a traffic situation and a road shape when the driver is unable to drive the vehicle on the basis of a detected driver's state.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a vehicle and a method of controlling the same, configured for performing an emergency stop on the vehicle in consideration of a traffic situation and a road shape when a driver is unable to drive the vehicle during traveling. In particular, various aspects of the present invention are directed to providing a vehicle and a method of controlling the same, configured for searching for a different stop position without stopping the vehicle when a road travelled on by a vehicle is inclined, such as a slope.

Additional aspects of the present invention will be set forth in part in the description which follows and, in part, will be obvious from the description, or may be learned by practice of the present invention.

Therefore, various aspects of the present invention are directed to providing a vehicle including: a detection sensor configured to detect an object around a vehicle; a driver state sensing unit configured to detect a driving state of a driver of the vehicle; an acceleration detection unit configured to detect a vehicle body acceleration of the vehicle; and a control unit configured to, upon determining that the driver is unable to control the vehicle on the basis of the detected driver state, determine a gradient of a road being travelled on by the vehicle on the basis of the detected vehicle body acceleration and determine a travel stop position and a travel stop time point of the vehicle on the basis of the determined gradient of the road.

The control unit may start a travel stop regarding control of the vehicle when the determined gradient of the road is less than a predetermined value, and may not start the travel stop regarding control of the vehicle when the determined gradient of the road is greater than or equal to the predetermined value.

The control unit may start the travel stop regarding control of the vehicle when the road having a gradient less than the predetermined value is secured with a predetermined distance.

The acceleration detection unit may include a longitudinal acceleration sensor configured to detect a longitudinal acceleration of the vehicle.

The driver state sensing unit may acquire gaze information related to the driver, wherein the control unit may determine a degree of risk regarding a negligence of keeping eyes of the driver forward on the basis of the acquired gaze information related to the driver and determine a vehicle control state of the driver on the basis of the determined degree of risk.

The vehicle may further include a photographing unit configured to photograph the road being travelled on by the vehicle, wherein the control unit may determine whether the road being travelled on by the vehicle is a vehicle exclusive road or a general road on the basis of map information related to the road or road information acquired by photographing the road.

The control unit, upon determining that the road being travelled on by the vehicle is the general road, may perform the travel stop regarding control on the vehicle such that the vehicle is stopped on an intersection of the general road.

The control unit may determine a travelling environment of the vehicle on the basis of at least one of a degree of traffic congestion of the road being travelled on by the vehicle and a shape of the road.

The control unit may determine the degree of traffic congestion of the road depending on whether a number of other vehicles around the vehicle detected by the detection sensor is greater than or equal to a predetermined number, and determine a time point of the travel stop regarding control of the vehicle on the basis of the determined degree of traffic congestion.

The control unit may start the travel stop regarding control of the vehicle when the number of the other vehicles around the vehicle is greater than or equal to the predetermined number, and determine the time point of the travel stop regarding control of the vehicle on the basis of the shape of the road when the number of the other vehicles around the vehicle is smaller than the predetermined number.

Various aspects of the present invention are directed to providing a method of controlling a vehicle, the method including: detecting an object around the vehicle; detecting a driving state of a driver of the vehicle; detecting a vehicle body acceleration of the vehicle; and upon determining that the driver is unable to control the vehicle on the basis of the detected driver state, determining a gradient of a road being travelled on by the vehicle on the basis of the detected vehicle body acceleration and determining a travel stop position and a travel stop time point of the vehicle on the basis of the determined gradient of the road.

The method may further include: starting a travel stop regarding control of the vehicle when the determined gradient of the road is less than a predetermined value, and not starting the travel stop regarding control of the vehicle when the determined gradient of the road is greater than or equal to the predetermined value.

The method may further include: starting the travel stop regarding control of the vehicle when the road having a gradient less than the predetermined value is secured with a predetermined distance.

The detecting of the vehicle body acceleration of the vehicle may include detecting a longitudinal acceleration of the vehicle.

The method may further include acquiring gaze information related to the driver, wherein the detecting of the driver state of the vehicle may include: determining a degree of risk regarding a negligence of keeping eyes of the driver forward on the basis of the acquired gaze information related to the driver; and determining a vehicle control state of the driver on the basis of the determined degree of risk.

The method may further include: photographing the road being travelled on by the vehicle, wherein the road being travelled on by the vehicle may be determined whether a vehicle exclusive road or a general road on the basis of map information related to the road or road information acquired by photographing the road.

When the road being travelled on by the vehicle is determined to be the general road, the travel stop regarding control of the vehicle may be performed such that the vehicle is stopped on an intersection of the general road.

The method may further include determining a travelling environment of the vehicle on the basis of at least one of a degree of traffic congestion of the road being travelled on by the vehicle and a shape of the road.

The travel stop time point of the vehicle may include: determining the degree of traffic congestion of the road depending on whether a number of other detected vehicles around the vehicle is greater than or equal to a predetermined number; and determining a time point of the travel stop regarding control of the vehicle on the basis of the determined degree of traffic congestion.

The method may further include: starting the travel stop regarding control of the vehicle when the number of the other vehicles around the vehicle is greater than or equal to the predetermined number; and determining the time point of the travel stop regarding control of the vehicle on the basis of the shape of the road when the number of the other vehicles around the vehicle is smaller than the predetermined number.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a vehicle having a detection sensor and a rear lateral side vehicle sensing unit according to an exemplary embodiment of the present invention;

FIG. 2 is a view exemplarily illustrating an internal structure of a vehicle according to an exemplary embodiment of the present invention;

FIG. 3 is a control block diagram illustrating a vehicle according to an exemplary embodiment of the present invention;

FIG. 4A, FIG. 4B and FIG. 4C are flowcharts showing a method of controlling a vehicle according to an exemplary embodiment of the present invention;

FIG. 5 is a view for describing an example in which gaze information related to a driver is acquired by a driver state sensing unit according to an exemplary embodiment of the present invention;

FIG. 6 is a view for describing an example in which drowsiness of a driver is determined according to an exemplary embodiment of the present invention;

FIG. 7 is a view for describing an example in which an emergency stop of a vehicle on a vehicle-road is controlled according to an exemplary embodiment of the present invention;

FIG. 8 is a view for describing an example in which an emergency stop of a vehicle on a general road is controlled according to an exemplary embodiment of the present invention; and

FIG. 9 and FIG. 10 are views for describing an example in which an emergency stop of a vehicle is controlled in consideration of a gradient of a road according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like numerals refer to like elements throughout the specification. Not all elements of embodiments of the present invention will be described, and description of what are commonly known in the art or what overlap each other in the exemplary embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in the present specification, specify the presence of stated features, integers, steps, operations, elements, and/or components, but do not preclude the presence or addition of one or more other features, integers, steps, operations, elements, components, and/or groups thereof, unless the context clearly indicates otherwise.

Although the terms “first,” “second,” “A,” “B,” etc. may be used to describe various components, the terms do not limit the corresponding components, but are used only for distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present invention will be described with reference to the accompanying drawings.

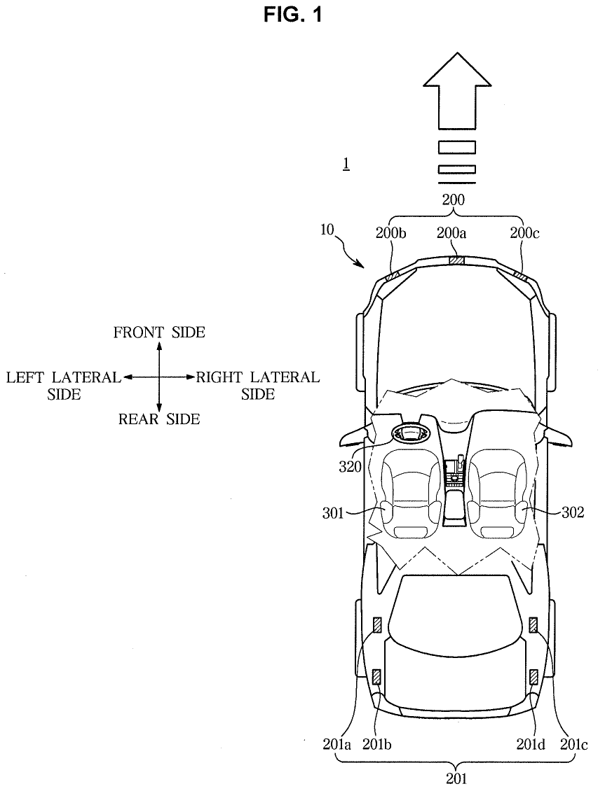

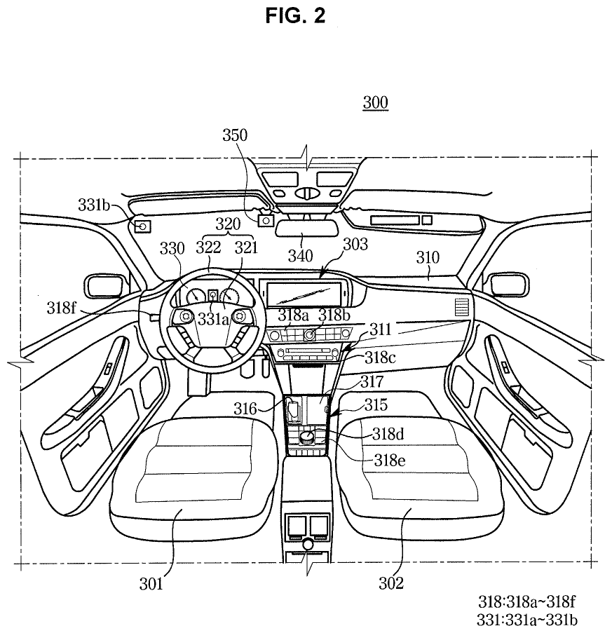

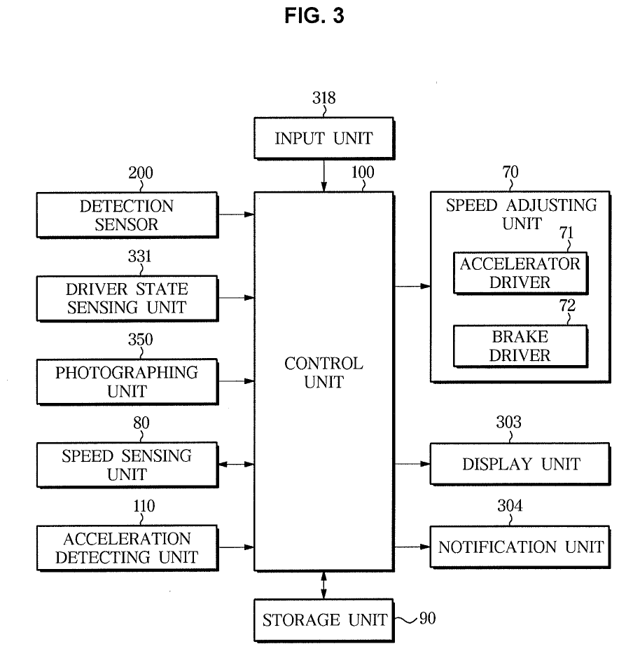

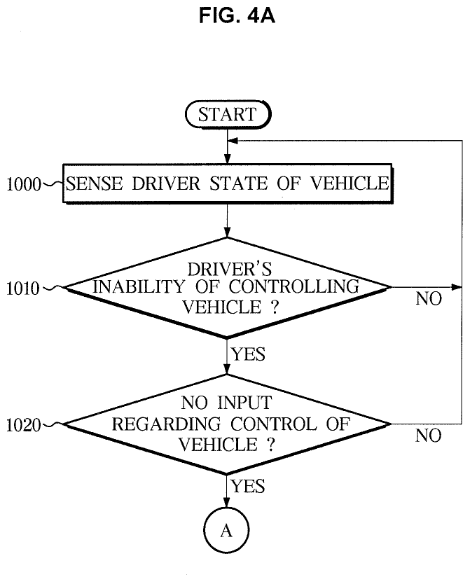

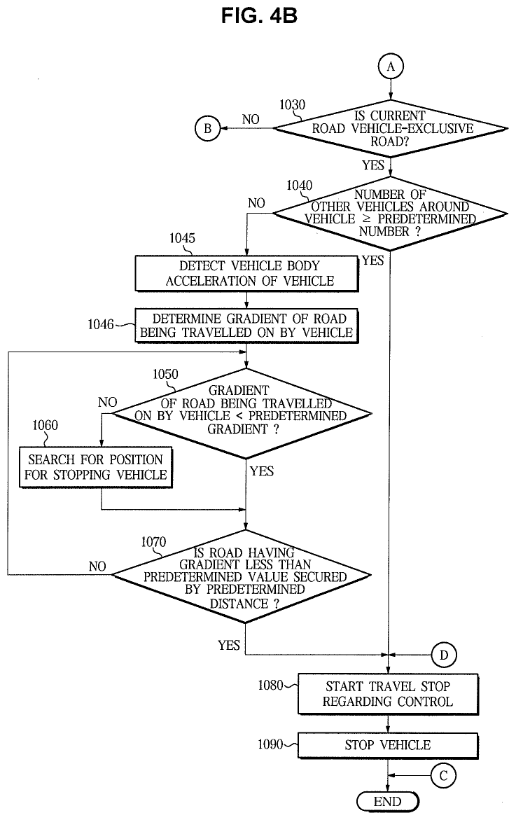

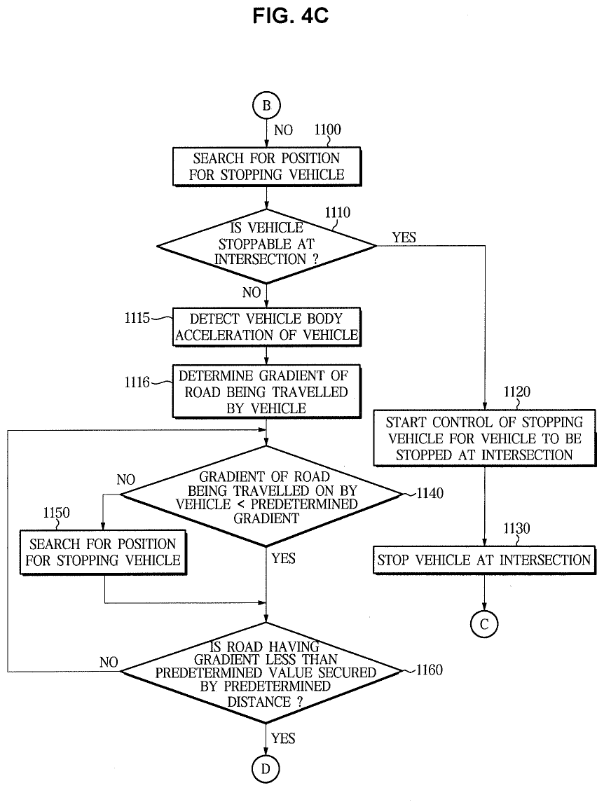

FIG. 1 is a view exemplarily illustrating a vehicle having a detection sensor and a rear lateral side vehicle sensing unit according to an exemplary embodiment of the present invention, FIG. 2 is a view exemplarily illustrating an internal structure of a vehicle according to an exemplary embodiment of the present invention, FIG. 3 is a control block diagram illustrating a vehicle according to an exemplary embodiment of the present invention, and FIG. 4A, FIG. 4B and FIG. 4C are flowcharts showing a method of controlling a vehicle according to an exemplary embodiment of the present invention.

For the sake of convenience in description, a direction in which the vehicle 1 advances is referred to as a forward of the vehicle, and a leftward direction and a rightward direction are distinguished with respect to the forward direction thereof, in which when the forward direction is a direction at 12 o'clock, a direction at 3 o'clock and a surrounding thereof are defined as the rightward direction thereof, and a direction at 9 o'clock and a surrounding thereof are defined as the leftward direction thereof. The opposite direction of the forward direction is the rearward direction thereof. Furthermore, a direction of the bottom portion of the vehicle is referred to as a downward direction thereof, and the opposite direction of the downward direction is referred to as the upward direction thereof. One side facing in the forward direction is referred to as a front side, one side facing in the rearward direction is referred to as a rear side, and sides disposed in a lateral direction are referred to as lateral sides, in which one of the lateral sides facing leftward is referred to as a left side, and the other one of the lateral sides facing rightward is referred to as a right side thereof.

Referring to FIG. 1, the vehicle 1 may be provided with a detection sensor 200 for detecting an object located in front of the vehicle 1 and acquiring at least one of positional information and traveling speed information related to the detected object.

The detection sensor 200 according to the exemplary embodiment may acquire at least one of position information and speed information related to an object located around the vehicle 1. That is, the detection sensor 200 may acquire coordinate information that changes in real time according to movement of the object, and may detect the distance between the vehicle 1 and the object.

As will be described below, a control unit (100 in FIG. 3) may determine the relative distance and the relative speed of the vehicle 1 and the object using the position information and the speed information related to the object acquired by the detection sensor 200, and may determine a collision expected time (a time to collision: TTC) of the vehicle 1 and the object on the basis of the relative distance and the relative speed.

Referring to FIG. 1, the detection sensor 200 may be mounted at a position suitable for recognizing an object (e.g., another vehicle) located on the front side, the lateral sides, or the front-lateral sides. According to the exemplary embodiment of the present invention, the detection sensor 200 may be mounted on the front side, the left side, and the right side to recognize all objects located in a forward direction thereof, a direction between the left side and the front side (hereinafter, referred to as a left front side), and a direction between the right side and the front side (hereinafter, referred to as a right front side).

For example, a first detection sensor 200a may be mounted on a portion of a radiator grille 6, for example, at an interior of the radiator grille 6, and may be mounted in any position of the vehicle 1 as long as it can detect a vehicle positioned in front of the vehicle 1. According to the exemplary embodiment of the present invention, the first detection sensor 200a is illustrated as being provided at the center portion of the front side of the vehicle 1 as an example. A second detection sensor 200b may be provided on the left side of the vehicle 1 and a third detection sensor 200c may be provided on the right side of the vehicle 1.

The detection sensor 200 may include a rear lateral side detection sensor 201 for detecting a pedestrian or another vehicle that exists on the rear side, the lateral side, or a side between the lateral side and the rear side of the vehicle 1 (hereinafter, referred to as a rear lateral side), or approaches from a direction corresponding thereto. The rear lateral side detection sensor 201 may be mounted at a position suitable for recognizing an object located on the lateral side, the rear side, or the rear lateral side, for example, another vehicle.

For example, the rear lateral side detection sensor 201 may be mounted on the left side and the right side of the vehicle 1 to recognize objects located in a direction between the left lateral side and the rear side (hereinafter, a left rear side) and a direction between the right side and the rear side (hereinafter, a right rear side). For example, a first rear lateral side detection sensor 201a or a second rear lateral side detection sensor 201b may be provided on the left side of the vehicle 1, and a third rear lateral side detection sensor 201c or a fourth rear lateral side detection sensor 201d may be provided on the right side of the vehicle 1.

The detection sensor 200 may be implemented using a radar using millimeter waves or microwaves, a light detection and ranging (LiDAR) using a pulse laser beam, a vision sensor using visible light, an infrared sensor using infrared rays, an ultrasonic sensor using ultrasonic waves, or the like. The detection sensor 200 may be implemented using one or a combination of these devices described above. When a plurality of detection sensors 200 are provided in one vehicle 1, each detection sensor 200 may be implemented with a single device, or may be implemented with separated devices. Furthermore, the detection sensor 200 may be implemented using various devices and combinations which may be considered by a designer.

Referring to FIG. 2, at least one photographing unit 350 may be provided in the vehicle 1. The photographing unit 350 may photograph a surrounding image of the vehicle 1 in a state of the vehicle 1 running or stationary, detect a target object around the vehicle 1, and acquire the type and the position information related to the object. The object photographed around the vehicle 1 may include another vehicle, a pedestrian, a bicycle, and the like, and may include a moving object or a stationary obstacle.

The photographing unit 350 may detect the type of an object around the vehicle by photographing the object, and performing image recognition to identify the shape of the photographed object, and may transmit the detected type information to the control unit 100.

In detail, the photographing unit 350 may acquire information related to the shape of a road on which the vehicle 1 travels by photographing the road.

Although the photographing unit 350 is illustrated as being provided around a rear view mirror 340 in FIG. 2, the location in which the photographing unit 350 is provided is not limited. The photographing unit 350 may be mounted on various positions of the vehicle 1 as long as it can acquire image information by photographing the inside or outside of the vehicle 1.

The photographing unit 350 may include at least one camera, and may include a three-dimensional space recognition sensor, a radar sensor, an ultrasonic sensor, or the like to photograph a more precise image.

Referring to FIG. 2, a vehicle interior 300 is provided with a driver's seat 301, an assistant seat 302, a dashboard 310, a steering wheel 320, and an instrument panel 330.

The dashboard 310 refers to a panel that divides the interior of the vehicle 1 from an engine compartment and on which various components required for driving are mounted. The dashboard 310 is provided in front of the driver's seat 301 and the assistant seat 302. The dashboard 310 may include an upper panel, a center fascia 311, a gear box 315, and the like.

A display unit 303 may be mounted on the upper panel of the dashboard 310. The display unit 303 may provide various pieces of information to the driver or passenger of the vehicle 1 as an image. For example, the display unit 303 may provide the driver or passenger with warning according to the degree of risk. In detail, when the vehicle 1 changes lanes, the display unit 303 may provide a different warning to the driver depending on the degree of risk. The display unit 303 may be implemented using a commonly used navigation device.

Furthermore, the display unit 303 may output an image of a target object located behind the vehicle 1 detected by the rear lateral side detection sensor 201. In detail, an image of a target object positioned behind the vehicle 1 photographed by a rear side photographing unit provided at the rear of the vehicle 1 may be provided to the driver through the display unit 303.

Various types of devices, such as a processor, a communication module, a satellite navigation device receiving module, a storage device, and the like, may be installed inside the dashboard 310. The processor installed in the vehicle may be provided to control various electronic devices installed in the vehicle 1, and may be provided to perform the functions of the control unit 100 as described above. The above-described devices may be implemented using various components, such as semiconductor chips, switches, integrated circuits, resistors, volatile or non-volatile memories, or printed circuit boards.

The center fascia 311 may be mounted at the center portion of the dashboard 310 and may include input units 318a to 318c for inputting various commands related to the vehicle 1. The input units 318a to 318c may be implemented using a physical button, a knob, a touch pad, a touch screen, a stick type operation device, or a trackball. The driver may control various operations of the vehicle 1 by operating the input units 318a to 318c.

The gear box 315 is provided between the driver's seat 301 and the assistant seat 302 at the lower end portion of the center fascia 311. The gear box 315 may be provided with a gear 316, a storage box 317, various input units 318d to 318e, and the like. The input units 318d to 318e may be implemented using a physical button, a knob, a touch pad, a touch screen, a stick type operation device, or a trackball. The storage box 317 and the input units 318d to 318e may be omitted according to embodiments.

The steering wheel 320 and the instrument panel 330 are provided on a side of the dashboard 310 adjacent to the driver's seat 301.

The steering wheel 320 is provided to rotate in a predetermined direction according to a manipulation of the driver, and as a front wheel or a rear wheel of the vehicle is rotated according to the rotation direction of the steering wheel 320, the vehicle 1 may be steered. The steering wheel 320 is provided with a spoke 321 connected to a rotation shaft and a grip wheel 322 coupled to the spoke 321. Furthermore, a turn signal input unit 318f may be provided at a rear side of the steering wheel 320. The user may input a signal for changing the travelling direction or the lane through the turn signal input unit 318f of the vehicle 1.

The instrument panel 330 is provided to provide a driver with various pieces of information related to the vehicle 1, such as the speed of the vehicle 1, the number of revolutions of the engine, the remaining amount of a fuel, the temperature of engine oil, the flicking state of the turn signal lamp, the travelled distance of the vehicle, and the like. The instrument panel 330 may be implemented using an illumination lamp, a scale plate, or the like, and may be implemented using a display panel according to embodiments. In the case where the instrument panel 330 is implemented using a display panel, the instrument panel 330 may display not only the above described information but also other various pieces of information, such as fuel efficiency, information related to performing various functions mounted on the vehicle 1, and the like. The instrument panel 330 may output a different warning to the driver depending on the degree of risk of the vehicle 1. In detail, the instrument panel 330 may provide a different warning to the driver depending on the determined degree of risk when the vehicle 1 changes lanes.

Furthermore, the instrument panel 330 may be provided with a driver state sensing unit 331a for detecting a driver state of the driver. The driver state sensing unit 331 (331a and 331b) may detect the current state of the driver who drives the vehicle 1. The driver state sensing unit 331 is a driver state warning system for monitoring a negligence of keeping eyes forward or a drowsiness of a driver of the vehicle 1.

For example, the driver state sensing unit 331 may detect at least one of a face angle and a pupil angle of the driver to acquire gaze information related to the driver, and may transmit the acquired gaze information related to the driver to the control unit 100.

Furthermore, the driver state sensing unit 331 may extract a face image from the image acquired through the camera and identify the driver state through the extracted face image. That is, the driver state sensing unit 331 may detect whether the driver is looking forward or whether the driver is driving while drowsy.

That is, the driver state sensing unit 331 may detect whether the driver is negligent of keeping eyes forward or unable to control the vehicle 1 in the current state by acquiring the gaze information or photographing the face or pupil of the driver.

The method of detecting the current state of the driver by the driver state sensing unit 331 may be implemented using various ways. Furthermore, although the driver state sensing unit 331a according to the exemplary embodiment of the present invention is illustrated as being provided on the instrument panel 330, there is no limitation on the position in which the driver state sensing unit 331a is mounted, and the driver state sensing unit 331a may be mounted at any position of the vehicle 1 as long as it can acquire driver state information, such as gaze information related to the driver. That is, as shown in FIG. 2, the driver state sensing unit 331b may be provided on the upper end portion of the driver's seat inside the vehicle 1.

The driver state sensing unit 331 may include a stereo camera for acquiring an image of a face or a pupil of a driver, and may be mounted at a position in which the driver's face or pupil is photographed to acquire gaze information related to the driver.

Referring to FIG. 3, the vehicle 1 according to the exemplary embodiment includes a speed adjusting unit 70 for adjusting a traveling speed of the vehicle 1 operated by the driver, a speed sensing unit 80 for detecting the traveling speed of the vehicle 1, a storage unit 90 for storing data related to the control of the vehicle 1, a control unit 100 for controlling each configuration of the vehicle 1 and controlling the travelling speed of the vehicle 1, an acceleration detection unit 110 for detecting the vehicle body acceleration of the vehicle 1, and a notification unit 304 for transmitting information to the driver in relation to the operation and travelling of the vehicle 1.

The speed adjusting unit 70 may adjust the speed of the vehicle 1 operated by the driver. The speed adjusting unit 70 may include an accelerator driver 71 and a brake driver 72.

The accelerator driver 71 increases the speed of the vehicle 1 by driving an accelerator in a response to receiving a control signal of the control unit 100, and the brake driver 72 decreases the speed of the vehicle 1 by driving a brake in a response to receiving a control signal of the control unit 100.

That is, the control unit 100 may determine the collision expected time between the vehicle 1 and the object on the basis of the relative distance and the relative speed of the vehicle 1 and the object, and may transmit a signal for controlling the traveling speed of the vehicle 1 on the basis of the determined collision expected time to the speed adjusting unit 70.

The speed adjusting unit 70 may adjust the traveling speed of the vehicle 1 under the control of the control unit 100. When the degree of risk of collision between the vehicle 1 and an object is high, the speed adjusting unit 70 may decrease the travelling speed of the vehicle 1.

The speed sensing unit 80 may detect the traveling speed of the vehicle 1 driven by the driver under the control of the control unit 100. That is, the speed sensing unit 80 may detect the traveling speed using the speed at which the wheel of the vehicle 1 is rotated, and the like. The unit of the traveling speed may be expressed in [kph], that is, the distance traveled per unit time (h).

The storage unit 90 may store various pieces of data related to the control of the vehicle 1. In detail, the storage unit 90 may store information related to the traveling speed, the traveling distance, and the traveling time of the vehicle 1 according to an exemplary embodiment of the present invention, and may store the type and position information related to the object detected by the photographing unit 350. Furthermore, the storage unit 90 may store position information and speed information related to the object detected by the detection sensor 200 and the rear lateral side detection sensor 201, and may store coordinate information related to a moving object which is changed in real time, and information related to the relative distance and the relative speed of the vehicle 1 and the object. Furthermore, the storage unit 90 may store data related to equations and control algorithms for controlling the vehicle 1 according to the exemplary embodiment of the present invention, and the control unit 100 may transmit a control signal for controlling the vehicle 1 according to the equations and control algorithms.

Furthermore, the storage unit 90 may store information related to a road on which the vehicle 1 is travelling. For example, the storage unit 90 may store Global Positioning System (GPS) information or road map information, and may store information related to the type and the shape of the road being travelling on by the vehicle 1 or the road to be traveled on by the vehicle.

The storage unit 90 may previously store information related to a gradient of the road on which the vehicle 1 may be stopped. In detail, as will be described below, the control unit 100 compares previously stored data of the gradient of a road on which the vehicle 1 may be stopped with a gradient of a road on which the vehicle 1 is currently travelling, to determine an emergency stop position and an emergency stop time point of the vehicle 1.

The storage unit 90 may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like, but the implementation of the storage unit 130 is not limited thereto. The storage unit 90 may be a memory implemented as a chip separated from the processor, which will be described below in connection with the control unit 120, or may be implemented as a single chip integrated with the processor.

The control unit 100 may be provided in at least one unit thereof in the vehicle 1. The control unit 100 may perform electronic control on each configuration related to the operation of the vehicle 1.

The acceleration detection unit 110 may detect vehicle body acceleration of the vehicle 1. That is, the acceleration detection unit 110 may detect the vehicle body acceleration of the vehicle 1 while on the travel and acquire acceleration information related to the vehicle 1. The acceleration detection unit 110 may include a longitudinal acceleration sensor for detecting longitudinal acceleration of the vehicle 1.

When the gaze of the driver of the vehicle 1 deviates from the front during travelling of the vehicle 1 or the driver of the vehicle 1 is unable to control or drive the vehicle 1 due to a sudden health abnormality of the driver, emergency stop needs to be performed on the vehicle 1. With the method of controlling the vehicle 1 according to the exemplary embodiment of the disclosed invention, the time point and position for the emergency stop control of the vehicle 1 may be determined in consideration of the type and shape of the road on which the vehicle 1 is travelling and the traffic situation of the vehicle 1.

, in the event of an emergency stop of the vehicle 1, the gradient of the road on which the vehicle 1 is located needs to be considered. In the case of a road sloped to have an inclination, when the vehicle 1 is subjected to an emergency stop on the vehicle 1 on the slopping road, other vehicles travelling around the vehicle 1 may not easily recognize the stopped vehicle 1, so that a secondary accident may occur. Furthermore, there is a chance that the vehicle 1 having being stopped moves due to the inclination of the road, so there is potential risk.

Accordingly, the vehicle according to the included embodiment and the method of controlling the same may, in the event of an emergency stop of the vehicle 1, control the vehicle 1 to be stopped at a different position rather than a slopping road in consideration of the gradient of the road on which the vehicle 1 is positioned.

Referring to FIG. 4A, the driver state sensing unit 331 provided in the vehicle 1 may detect the driver state of the vehicle 1 (1000).

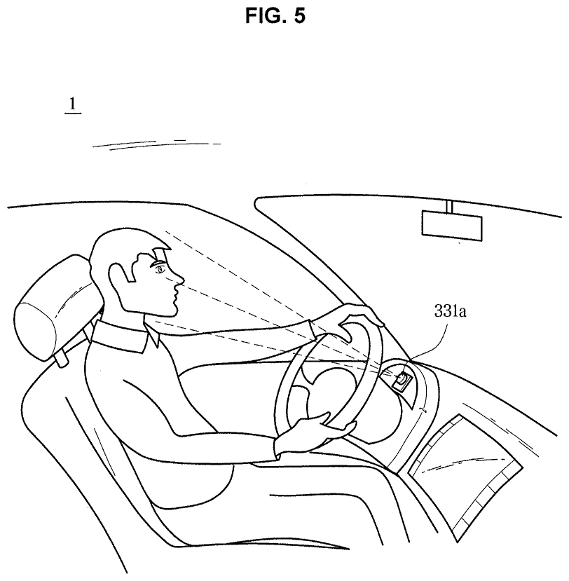

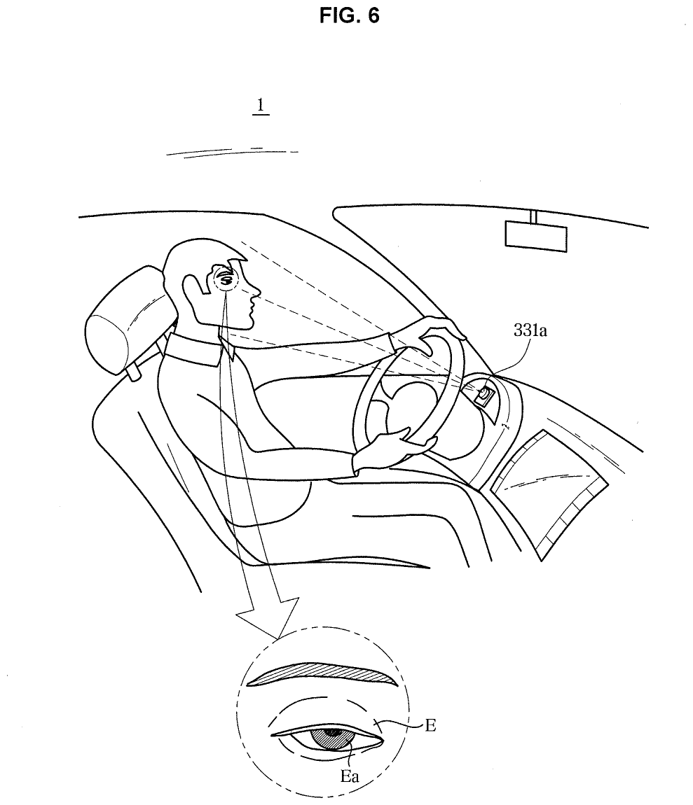

FIG. 5 is a view for describing an example in which gaze information related to a driver by a driver state sensing unit is acquired according to an exemplary embodiment of the present invention, and FIG. 6 is a view for describing an example in which drowsiness of a driver is determined according to an exemplary embodiment of the present invention.

Referring to FIG. 5, the driver state sensing unit 331 may acquire gaze information related to the driver. That is, the face or the eyes of the driver who drives the vehicle 1 may be photographed through a photographing module, such as a camera provided in the driver state sensing unit 331, and information related to the face angle of the driver, the pupil angle, and the like may be acquired. Such a camera may include a plurality of gaze detection sensors.

The control unit 100 may determine the degree of risk of the driver regarding negligence of keeping eyes forward on the basis of the gaze information related to the driver acquired by the driver state sensing unit 331, and may determine a vehicle control state of the driver on the basis of the determined degree of risk (1010).

In detail, the control unit 100 may determine whether the gaze of the driver of the vehicle 1 deviates from the travelling direction of the vehicle 1 by a predetermined angle or Moreover, and when it is determined that the gaze of the driver is determined to deviate from the travelling direction 1 by the predetermined angle or Moreover, may determine the degree of risk regarding the negligence of keeping eyes forward thereof.

The control unit 100 may determine that the driver is unable to drive the vehicle 1 when the degree of risk regarding the negligence of keeping eyes forward corresponds to a predetermined value.

Referring to FIG. 6, the control unit 100 may determine whether the area of a pupil Ea is less than a predetermined area with respect to the area of an eye ball E of the driver photographed by the driver state sensing unit 331, and when the area of the pupil Ea is less than the predetermined area, the driver may be determined to drive while drowsy. Furthermore, the control unit 100, upon determining that the driver to drive while drowsy, may determine the degree of risk related to negligence of keeping eyes forward to a predetermined value.

That is, since the risk of an accident increases when the driver drives while drowsy during travelling of the vehicle 1 as shown in FIG. 6, the control unit 100 compares the area of the pupil Ea photographed by a user terminal 200 with a predetermined reference area stored in the storage unit 90, and when the area of the pupil Ea is equal to or less than the predetermined reference area, determine that the eyes of the driver are closed to some extent.

The control unit 100 may determine that the driver is currently unable to drive the vehicle 1 when the degree of risk determined by the drowsiness of the driver corresponds to the predetermined value.

The control unit 100, upon determining that the driver is unable to control the vehicle 1, may determine whether an input regarding the control of the vehicle 1 is currently being received from the driver (1020).

That is, even when the control unit 100 determines that the driver is unable to control the vehicle 1, the determination on the drive's inability of controlling the vehicle 1 may canceled when an input regarding the control of the vehicle 1 is received from the driver.

However, when an input regarding the control of the vehicle 1 is not received from the driver, the control unit 100 determines that the driver is currently unable to control the vehicle 1, and controls an emergency stop to be performed on the vehicle 1.

That is, upon determining that the driver 1 is unable to control the vehicle 1, the control unit 100 may determine a travel stop position and a travel stop time point on the basis of at least one of the type of the road on which the vehicle 1 is travelling or the travelling environment.

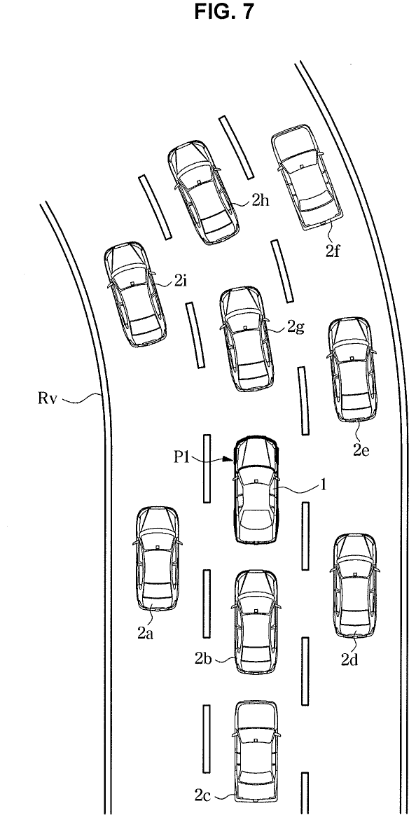

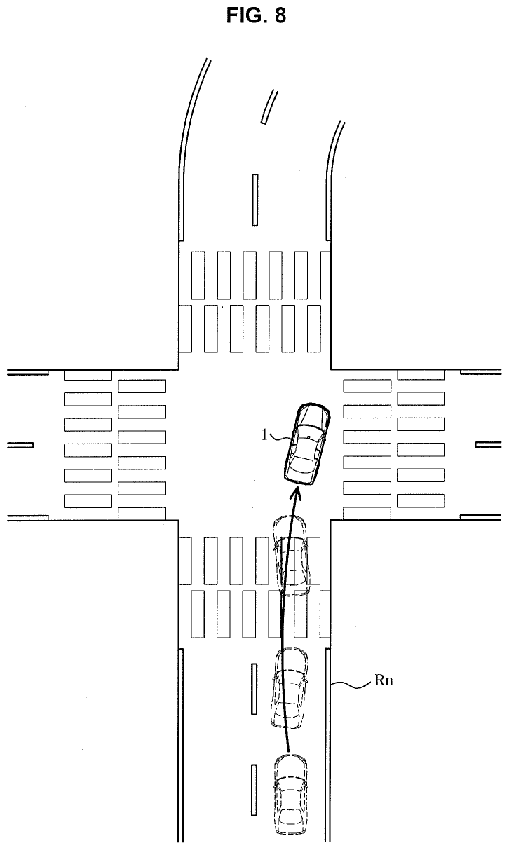

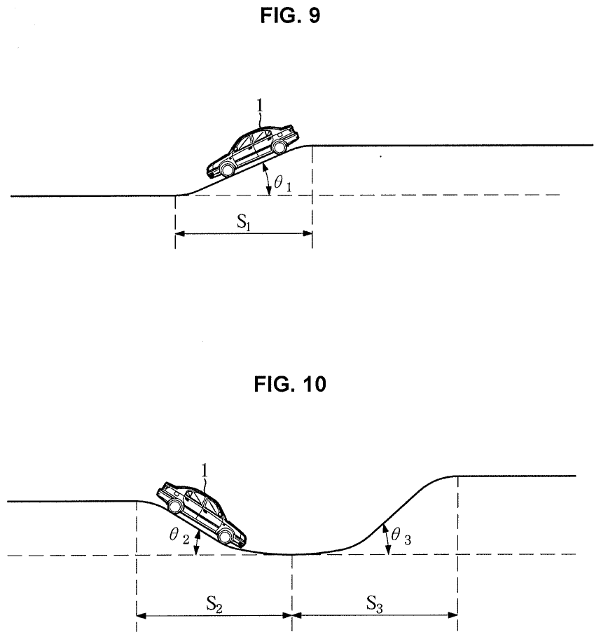

FIG. 7 is a view for describing an example in which an emergency stop of a vehicle on a vehicle exclusive road is controlled according to an exemplary embodiment of the present invention, FIG. 8 is a view for describing an example in which an emergency stop of a vehicle on a general road is controlled according to an exemplary embodiment of the present invention, and FIG. 9 and FIG. 10 are views for describing an example in which an emergency stop of a vehicle is controlled in consideration of a gradient of a road according to an exemplary embodiment of the present invention.

The control unit 100 may determine the type of a road currently being travelled on by the vehicle 1, for emergency stop of the vehicle 1 (1030). That is, the control unit 100 may determine whether the road being travelled on by the vehicle 1 is a vehicle road or a general road on the basis of road information photographed by the photographing unit 350 or map information related to the road.

When the road being travelled on by the vehicle 1 is a vehicle exclusive road, the road allows only vehicles to be travelled thereon. On the other hand, a general road allows other transportation devices except for a vehicle to exist thereon, and further allows a pedestrian to exist thereon.

That is, the type of the vehicle allowed to be travelled on the road and the degree of traffic congestion of the road vary depending on the type of the road being travelled on by the vehicle 1, so that the control unit 100 controls the position and the time point for emergency stop of the vehicle 1 to vary.

The control unit 100 may determine the s position and the time point of stopping the vehicle 1 on the basis of the degree of traffic congestion of the road when the type of the road travelled on by the vehicle 1 is a vehicle exclusive a road.

The control unit 100 may determine the degree of traffic congestion of the road being travelled on by the vehicle 1 on the basis of the positions and speeds of nearby vehicles detected by the detection sensor 200. Furthermore, the control unit 100 may determine the degree of traffic congestion on the basis of the number of nearby vehicles, and the degree of traffic congestion may be determined on the basis of a predetermined number of other vehicles.

Referring to FIG. 7, when the control unit 100 determines that the driver is unable to control the vehicle 1 at a time of travelling on a point P1 of a vehicle exclusive road Rv, the control unit 100 may determine a time point of the travel stop regarding control according to whether the number of other vehicles located around the vehicle 1 is equal to or greater than a predetermined number (1040).

For example, the control unit 100 may determine the degree of traffic congestion to a predetermined value when other vehicles 2e, 2f, 2g, 2h, and 2i located in front of the vehicle 1 are more than a predetermined reference number of 3, and other vehicles 2a, 2b, 2c, and 2d located behind the vehicle 1 are more than a predetermined reference number of 3, and may immediately perform a travel stop regarding control on the vehicle 1 on the basis of the determined degree of traffic congestion (1080). Accordingly, the vehicle 1, incapable of being controlled by the driver may be brought to an emergency stop on the road (1090).

That is, when the degree of traffic congestion is high due to other vehicles being located around the travelling vehicle 1, the vehicle 1 needs to be urgently stopped to prevent an accident from occurring with the other vehicles due to the driver's inability of controlling the vehicle 1. Accordingly, the control unit 100 may detect the driver's inability of controlling the vehicle 1 and may immediately start the travel stop regarding control of the vehicle at the time when the degree of traffic congestion of the road is determined.

The control unit 100 may control the steering of the vehicle 1 to determine the stop position of the vehicle 1, and may control the speed adjusting unit 70 to decelerate the travelling speed of the vehicle 1 at a predetermined deceleration.

Furthermore, the control unit 100 may perform the travel stop regarding control on the vehicle 1 while controlling travel of the vehicle 1 on deceleration, to prevent the vehicle 1 from entering another lane on the basis of the lane keeping assist system.

The control unit 100 may delay the time point of stopping the vehicle 1 while on travelling without immediately starting the travel stop regarding control of the vehicle 1 when the number of other vehicles located around the vehicle 1 is less than the predetermined reference value, and may search for a position in which an emergency stop is performed on the vehicle 1, in consideration of the shape of the road and the travelling environment of the vehicle 1.

That is, the control unit 100 may acquire information related to the shape of the road being travelled on by the vehicle 1 on the basis of the road image photographed by the photographing unit 350 or the map information related to the road, and may determine the travelling environment of the vehicle 1 on the basis of the acquired shape of the road.

Furthermore, the acceleration detection unit 110 may detect the vehicle body acceleration of the vehicle 1 (1045), and the control unit 100 may determine the gradient of the road being travelled on by the vehicle 1 on the basis of the vehicle body acceleration of the vehicle 1 detected by the acceleration detection unit 110 (1046).

The acceleration detection unit 110 may include a longitudinal acceleration sensor for detecting the longitudinal acceleration of the vehicle 1. The control unit 100 acquires data regarding a gradient of the road on which the vehicle 1 is located on the basis of wheel acceleration information acquired by differentiating the rotation speed of the wheels of the vehicle 1 and acceleration information detected by the acceleration detection unit 110.

That is, the control unit 100 receives the rotation speeds of the wheels detected at a predetermined time interval by a predetermined number of times, averages the rotation speeds of the wheels detected by the predetermined number of times, divides the average wheel rotation speed by a predetermined time to acquire a wheel acceleration, and compares the wheel acceleration with the acceleration of the vehicle 1 detected by the acceleration detection unit 110 to obtain a gradient value of the road on which the vehicle 1 is currently located.

The control unit 100 may determine the travel stop position and the travel stop time point of the vehicle 1 on the basis of the gradient of the road currently being travelled on by the vehicle 1.

In detail, the control unit 100 may compare a gradient of a vehicle road Rv being travelled on by the vehicle 1 with a predetermined gradient value stored in the storage unit 90 (1050), and upon determining that the gradient of the road on which the vehicle 1 is located is equal to or greater than the predetermined value, may search for a different position for stopping the vehicle 1 without starting the control of stopping the travel of the vehicle 1 (1060).

Referring to FIG. 9, when the road being travelled on by the vehicle 1 is a slope S1 having a gradient of θ1, the control unit 100 may control the vehicle not to be stopped on the slope S1 even when an emergency stop of the vehicle 1 is required. That is, when the vehicle 1 is brought to an emergency stop on the slope S1, other vehicles running behind the vehicle 1 may not recognize the vehicle 1, and the stopped vehicle 1 may be rolling the slope S1.

Accordingly, when the road on which the vehicle 1 is located has a gradient θ1 equal to or greater than a predetermined value, the control unit 100 controls the vehicle 1 to search for a different position available for stopping the vehicle 1 without bringing the vehicle 1 to an emergency stop.

Furthermore, referring to FIG. 10, when the road being travelled on by the vehicle 1 is a slope S2 having a gradient of θ2, the control unit 100 may control the vehicle not to be stopped on the slope S2 even when an emergency stop of the vehicle 1 is required. That is, when the vehicle 1 is brought to an emergency stop on the slope S2, other vehicles running behind the vehicle 1 may not recognize the vehicle 1, and the stopped vehicle 1 may be rolling on the slope S2.

Accordingly, when the road on which the vehicle 1 is located has a gradient θ2 equal to or greater than a predetermined value, the control unit 100 controls the vehicle 1 to search for a different position available for stopping the vehicle 1 without bringing the vehicle 1 to an emergency stop.

On the other hand, when the vehicle 1 is moved to the different position according to the control of the control unit 110 but the road on which the vehicle 1 is located is also a slope S3 having a gradient of θ3 as shown in FIG. 10, the control unit 100 may control the vehicle 1 not to be stopped on the slope S3, similarly to the above situations.

Accordingly, when the road on which the vehicle 1 is located has a gradient θ3 equal to or greater than a predetermined value as shown in FIG. 10, the control unit 100 controls the vehicle 1 to search for a different position available for stopping the vehicle 1 without bringing the vehicle 1 to an emergency stop.

On the other hand, upon determining that the gradient of the road on which the vehicle 1 is located is less than the predetermined value, the control unit 100 determines whether the road having a gradient less than the predetermined value is secured with a predetermined distance from a position of the vehicle 1 (1070).

That is, when the driver is unable to control the vehicle 1, when the vehicle 1 is subject to an emergency stop on a road having a large gradient, the risk of collision with another vehicle while on the move may increase. Accordingly, to prevent rear side collision and secondary accident, the control unit 100 may delay the time point of stopping the vehicle 1 until a road having no inclination or having a gradient less than or equal to a predetermined value is secured with a predetermined distance.

Accordingly, referring to FIG. 9 and FIG. 10, the control unit 100 does not immediately stop the vehicle 1 even upon detecting the driver's inability to control the vehicle 1 at the slopes S1, S2, and S3, but controls the Smart Cruise Control System such that the vehicle 1 passes through a road having a predetermined gradient or greater.

That is, the control unit 100 may control the vehicle 1 to pass through the slopes S1, S2, and S3 shown in FIG. 9 and FIG. 10 up to a road point having no gradient, and when a road being travelled by the vehicle 1 is a road having a gradient less than or equal to a predetermined value, the control unit 100 may start the travel stop regarding control such that the vehicle 1 is stopped (1080). Accordingly, the vehicle 1 travelling in a state in which the driver is unable to control the vehicle 1 may be stopped on a road having no inclination (1090).

Referring again to FIG. 8, when the type of the road travelled on by the vehicle 1 is a general road Rn and the driver is unable to control the vehicle 1, the control unit 100 searches for a position for stopping the vehicle 1 on the road, (1100), and may perform the control of stopping the vehicle 1 such that the vehicle 1 is stopped at the intersection of the general road.

That is, the driver's inability to control the vehicle 1 may be attributed to a health condition of the driver, and in that case, the control unit 100 may control the vehicle 1 to be stopped at the intersection such that the abnormal health condition of the driver is rapidly noticed after the vehicle 1 being stopped, and an emergency measure is easily performed.

The control unit 100 may determine whether the vehicle 1 travelling on the general road may be stopped at the intersection on the basis of the traffic condition of the road and the presence or absence of other obstacles, such as other vehicles (1110). When it is determined as a result of the determination in operation 1110 that there is no difficulty in stopping the vehicle 1 at the intersection, the control unit 100 may start the control of stopping the vehicle 1 (1120) so that the vehicle 1 is stopped at the intersection (1130).

On the other hand, when it is determined as a result of the determination in operation 1110 that there is a difficulty in stopping the vehicle 1 at the intersection, the control unit 100 may delay the start time point without immediately starting the control of stopping the vehicle 1, and may search for a position for bringing the vehicle 1 to an emergency stop in consideration of the shape of the road being travelled by the vehicle 1 and the travelling environment.

That is, the control unit 100 may acquire information related to the shape of the road being travelled by the vehicle 1 on the basis of the road image photographed by the photographing unit 350 or the map information related to the road, and may determine the travelling environment of the vehicle 1 on the basis of the acquired shape of the road.

Furthermore, the acceleration detection unit 110 may detect the vehicle body acceleration of the vehicle 1 (1115), and the control unit 100 may determine the gradient of the road being travelled by the vehicle 1 on the basis of the vehicle body acceleration of the vehicle 1 detected by the acceleration detection unit 110 (1116).

The control unit 100 may determine the travel stop position and the travel stop time point of the vehicle 1 on the basis of the gradient of the road being travelled on by the vehicle 1.

In detail, the control unit 100 may compare the gradient of the general road Rn being travelled on by the vehicle 1 with a predetermined gradient value stored in the storage unit 90 (1140), and when it is determined as a result of the comparison that the gradient of the road on which the vehicle 1 is located is greater than or equal to a predetermined value, the control unit 100 may search for a different position available for stopping the vehicle 1 without starting the control of stopping the travelling vehicle 1 (1150).

As described above with reference to FIG. 9, when the general road Rn being travelled on by the vehicle 1 is a slope S1 having a gradient of θ1, the control unit 100 may control the vehicle 1 not to be stopped on the slope S1 even when an emergency stop of the vehicle 1 is required.

Accordingly, when the road on which the vehicle 1 is located has a gradient θ1 equal to or greater than a predetermined value, the control unit 100 may control the vehicle 1 to search for a different position available for stopping the vehicle 1 without bringing the vehicle 1 to an emergency stop.

Furthermore, as described above with reference to FIG. 10, when the general road Rn being travelled on by the vehicle 1 is a slope S2 having a gradient of θ2, the control unit 100 may control the vehicle 1 not to be stopped on the slope S1 even when an emergency stop of the vehicle 1 is required.

Accordingly, when the road on which the vehicle 1 is located has a gradient θ2 equal to or greater than a predetermined value, the control unit 100 may control the vehicle 1 to search for a different position available for stopping the vehicle 1 without bringing the vehicle 1 to an emergency stop.

On the other hand, when the vehicle 1 is moved to the different position according to the control of the control unit 110 but the general road Rn on which the vehicle 1 is located is also a slope S3 having a gradient of θ3, the control unit 100 may control the vehicle 1 not to be stopped on the slope S3, similarly to the above.

Accordingly, when the road on which the vehicle 1 is located has a gradient θ3 equal to or greater than a predetermined value, the control unit 100 controls the vehicle 1 to search for a different position available for stopping the vehicle 1 without bringing the vehicle 1 to an emergency stop.

On the other hand, upon determining that the gradient of the general road Rn on which the vehicle 1 is located is less than the predetermined value, the control unit 100 determines whether the general road Rn having a gradient less than the predetermined value is secured with a predetermined distance is secured at a position of the vehicle 1 (1160).

That is, when the driver is unable to control the vehicle 1 on a road having a large gradient, the risk of collision with another vehicle while on the travel may increase. Accordingly, to prevent rear collision and secondary accident, the control unit 100 may delay the time point of stopping the vehicle 1 until a road having no inclination or a gradient less than or equal to a predetermined value is secured a predetermined distance is secured.

Accordingly, referring to FIG. 9 and FIG. 10, the control unit 100 does not immediately stop the vehicle 1 even upon detecting the driver's inability to control the vehicle 1 at slopes S1, S2, and S3, but controls the Smart Cruise Control System such that the vehicle 1 passes through a road having a predetermined gradient or greater.

That is, the control unit 100 may control the vehicle 1 to pass through the slopes S1, S2, and S3 shown in FIG. 9 and FIG. 10 up to a road point having no gradient, and when a road being travelled by the vehicle 1 is a road having a gradient less than or equal to a predetermined value, the control unit 100 may start the travel stop regarding control such that the vehicle 1 is stopped (1080). Accordingly, the vehicle 1 travelling in a state in which the driver is unable to control the vehicle 1 may be stopped on a road having no inclination (1090).

As described above, with the vehicle 1 and the method of controlling the vehicle 1 according to the exemplary embodiment of the disclosed invention, when the driver 1 is unable to drive the vehicle 1 while on the travel, an emergence stop of the vehicle 1 is performed in consideration of the traffic situation and the shape of the road, keeping the lane even in the event of an emergency situation and securing the safety of the travelling vehicle 1 and the rear vehicle.

The vehicle and the method of controlling the same can search for a different stop position without stopping the vehicle when a road travelled on by a vehicle has an inclination, such as a slope, so that an emergency stop of the vehicle may be safely performed.

Meanwhile, the disclosed exemplary embodiments may be embodied in a form of a recording medium storing instructions executable by a computer. The instructions may be stored in a form of program code and, when executed by a processor, may generate a program module to perform the operations of the included exemplary embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

As is apparent from the above, the vehicle according to an exemplary embodiment of the present invention and the method of controlling the same can perform an emergency stop on the vehicle in consideration of a traffic situation and a road shape when a driver is unable to drive the vehicle during traveling, keeping the lane even in the event of an emergency situation and securing the safety of the travelling vehicle and the rear vehicle. The vehicle according to an exemplary embodiment of the present invention and the method of controlling the same can search for a different stop position without stopping the vehicle when a road travelled on by a vehicle is inclined, such as a slope, performing an emergency stop on the vehicle safely.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle comprising:
a detection sensor configured to detect an object around the vehicle;
a driver state sensing unit configured to detect a driving state of a driver of the vehicle;
an acceleration detection unit configured to detect a vehicle body acceleration of the vehicle; and
a control unit configured to, upon determining that the driver is unable to control the vehicle on a basis of the detected driving state of the driver, determine a gradient of a road being travelled on by the vehicle on a basis of the detected vehicle body acceleration and to determine a travel stop position and a travel stop time point of the vehicle on a basis of the determined gradient of the road.

2. The vehicle of claim 1, wherein the control unit is configured to start a travel stop regarding control of the vehicle upon determining that the determined gradient of the road is less than a predetermined value, and is configured to not start the travel stop regarding control of the vehicle upon determining that the determined gradient of the road is greater than or equal to the predetermined value.

3. The vehicle of claim 2, wherein the control unit is configured to start the travel stop regarding control of the vehicle upon determining that the road having a gradient less than the predetermined value is secured with a predetermined distance.

4. The vehicle of claim 1, wherein the acceleration detection unit includes a longitudinal acceleration sensor configured to detect a longitudinal acceleration of the vehicle.

5. The vehicle of claim 1,
wherein the driving state of the driver sensing unit includes gaze information related to the driver, and
wherein the control unit is configured to determine a degree of risk regarding a negligence of keeping eyes of the driver forward on a basis of the gaze information related to the driver and is configured to determine a vehicle control state of the driver on a basis of the determined degree of risk.

6. The vehicle of claim 1, further including:
a photographing unit configured to capture an image of the road being travelled on by the vehicle,
wherein the control unit is configured to determine when the road being travelled on by the vehicle is a vehicle exclusive road or a general road on a basis of map information related to the road or road information acquired by capturing the image of the road.

7. The vehicle of claim 6, wherein the control unit, upon determining that the road being travelled on by the vehicle is the general road, is configured to perform the travel stop regarding control on the vehicle so that the vehicle is stopped on an intersection of the general road.

8. The vehicle of claim 1, wherein the control unit is configured to determine a travelling environment of the vehicle on a basis of at least one of a degree of traffic congestion of the road being travelled on by the vehicle and a shape of the road.

9. The vehicle of claim 8, wherein the control unit is configured to determine the degree of traffic congestion of the road depending on when a number of other vehicles around the vehicle detected by the detection sensor is greater than or equal to a predetermined number, and is configured to determine a time point of a travel stop regarding control of the vehicle on a basis of the determined degree of traffic congestion.

10. The vehicle of claim 9, wherein the control unit is configured to start the travel stop regarding control of the vehicle upon determining that a number of the other vehicles around the vehicle is greater than or equal to the predetermined number, and is configured to determine a time point of the travel stop regarding control of the vehicle on a basis of the shape of the road upon determining that the number of the other vehicles around the vehicle is smaller than the predetermined number.

11. A method of controlling a vehicle, the method including:
detecting an object around the vehicle;
detecting a driving state of a driver of the vehicle;
detecting a vehicle body acceleration of the vehicle; and
upon determining that the driver is unable to control the vehicle on a basis of the detected driving state of the driver, determining, by a controller, a gradient of a road being travelled on by the vehicle on a basis of the detected vehicle body acceleration and determining a travel stop position and a travel stop time point of the vehicle on a basis of the determined gradient of the road.

12. The method of claim 11, further including:
starting a travel stop regarding control of the vehicle, upon determining that the determined gradient of the road is less than a predetermined value, and
not starting the travel stop regarding control of the vehicle, upon determining that the determined gradient of the road is greater than or equal to the predetermined value.

13. The method of claim 12, further including:
starting the travel stop regarding control of the vehicle, upon determining that the road having a gradient less than the predetermined value is secured with a predetermined distance.

14. The method of claim 11, wherein the detecting of the vehicle body acceleration of the vehicle includes detecting a longitudinal acceleration of the vehicle.

15. The method of claim 11, further including acquiring gaze information related to the driver,
wherein the detecting of the driving state of the driver of the vehicle includes:
determining a degree of risk regarding a negligence of keeping eyes of the driver forward on a basis of the acquired gaze information related to the driver; and
determining a vehicle control state of the driver on a basis of the determined degree of risk.

16. The method of claim 11, further including:
capturing an image of the road being travelled on by the vehicle,
wherein determining when the road being travelled on by the vehicle is a vehicle exclusive road or a general road on a basis of map information related to the road or road information acquired by capturing the image of the road.

17. The method of claim 16, wherein upon determining that the road being travelled on by the vehicle is determined to be the general road, the travel stop regarding control of the vehicle is performed so that the vehicle is stopped on an intersection of the general road.

18. The method of claim 11, further including determining a travelling environment of the vehicle on a basis of at least one of a degree of traffic congestion of the road being travelled on by the vehicle and a shape of the road.

19. The method of claim 18, wherein the travel stop time point of the vehicle includes:
determining the degree of traffic congestion of the road depending on when a number of other detected vehicles around the vehicle is greater than or equal to a predetermined number; and
determining a time point of the travel stop regarding control of the vehicle on a basis of the determined degree of traffic congestion.

20. The method of claim 19, further including:
starting the travel stop regarding control of the vehicle upon determining that the number of the other vehicles around the vehicle is greater than or equal to the predetermined number; and
determining the time point of the travel stop regarding control of the vehicle on a basis of the shape of the road upon determining that the number of the other vehicles around the vehicle is lower than the predetermined number.
